(19) United States
(12) Patent Application Publication
(10) Pub. No.: US 2018/0357944 A1
(43) Pub. Date: Dec. 13, 2018

(54) OPTICAL COMPENSATION APPARATUS APPLIED TO PANEL AND OPERATING METHOD THEREOF

(71) Applicant: Raydium Semiconductor Corporation, Hsinchu (TW)

(72) Inventors: Shang-Ping TANG, Zhubei City (TW); Hung LI, Taipei City (TW)

(21) Appl. No.: 16/002,157

(22) Filed: Jun. 7, 2018

Related U.S. Application Data
(60) Provisional application No. 62/516,706, filed on Jun. 8, 2017.

(51) Int. Cl. G09G 3/00; G09G 3/20; G09G 3/3208

(52) U.S. Cl. CPC G09G 3/006; G09G 3/2003; G09G 2310/027; G09G 2320/0242; G09G 2320/0233; G09G 3/3208

(57) ABSTRACT

An optical compensation apparatus applied to a panel is disclosed. The panel includes sub-pixels for displaying a display data. The optical compensation apparatus includes an optical measurement module, a data processing module and an optical compensation module. The optical measurement module is used to measure optical measurement values corresponding to the sub-pixels of the panel. The data processing module is coupled to the optical measurement module and used for determining whether the sub-pixels are abnormal according to the optical measurement values. If the above determining result is yes, the data processing module generates at least one optical compensation value corresponding to at least one abnormal sub-pixel according to a specific processing rule. The optical compensation module is coupled to the data processing module and used for outputting the optical compensation value to perform optical compensation on the display data.

### BACKGROUND OF THE INVENTION

### 1. Field of the Invention

The invention relates to a panel; in particular, to an optical compensation apparatus applied to the panel and an operating method thereof.

### 2. Description of the Prior Art

Current organic light-emitting diode (OLED) panels often suffer from mura and affect their yield. The so-called “mura” refers to various traces caused by non-uniform brightness of the panel. Since the mura generally exists on the background of uneven light source, it is impossible for the human eye to effectively distinguish between normal image and mura. As a result, many techniques for correcting mura have emerged.

A common mura correction method at present is to firstly measure the brightness of each sub-pixel of the panel to determine whether each sub-pixel has mura, and then to change the data signal outputted to each sub-pixel of the panel accordingly and then achieve the effect of lightness compensation.

However, since such this mura correction method needs to measure the brightness of each sub-pixel of the panel at first, the requirement for the surface cleanness of the panel is very high to ensure the accuracy of the lightness measurement values. For example, it is assume that FIG. 1A shows the original panel 1, and the normal lightness values of the sub-pixels P1˜P11 are shown in FIG. 1B; once the dust 2 or other interferences are present on the panel 1 during the lightness measurement process as shown in FIG. 2A, the lightness measured from the pixels (e.g., P3, P4, P9) covered by the dust 2 on the display panel 1 will be much lower than the normal lightness as shown in FIG. 2B. As a result, as shown in FIG. 3B, after performing error compensation on the sub-pixels (e.g., P3, P4, P9) according to the erroneous lightness measurement values, abnormal bright spots 3 will be presented on the sub-pixels (e.g., P3, P4, P9) of the panel 1 as shown in FIG. 3A.

### SUMMARY OF THE INVENTION

Therefore, the invention provides an optical compensation apparatus applied to the panel and an operating method thereof to solve the above-mentioned problems of the prior arts.

A preferred embodiment of the invention is an optical compensation apparatus. In this embodiment, the optical compensation apparatus is applied to a panel. The panel includes a plurality of sub-pixels for displaying a display data. The optical compensation apparatus includes an optical measurement module, a data processing module and an optical compensation module. The optical measurement module is used for measuring a plurality of optical measurement values corresponding to the plurality of sub-pixels of the panel. The data processing module is coupled to the optical measurement module and used for determining whether the plurality of sub-pixels is abnormal according to the plurality of optical measurement values. If a determining result of the data processing module is yes, the data processing module generates at least one optical compensation value corresponding to at least one abnormal sub-pixel of the plurality of sub-pixels according to a specific processing rule. The optical compensation module is coupled to the data processing module and used for outputting the at least one optical compensation value to perform optical compensation on the display data.

In an embodiment, the panel is an organic light-emitting diode (OLED) panel.

In an embodiment, the plurality of optical measurement values is lightness values of the plurality of sub-pixels.

In an embodiment, the optical measurement module includes a control unit, an optical sensing unit and a data accessing unit. The control unit is used for providing a control signal. The optical sensing unit is coupled to the control unit and used for performing optical sensing on the plurality of sub-pixels of the panel according to the control signal to obtain the plurality of optical measurement values. The data accessing unit is coupled to the optical sensing unit and used for accessing the plurality of optical measurement values from the optical measuring unit.

In an embodiment, the data processing module includes a data analyzing unit, an abnormal determination unit and a data processing unit. The data analyzing unit is coupled to the optical measurement module used for receiving and analyzing the plurality of optical measurement values. The abnormal determination unit is coupled to the data analyzing unit and used for determining whether the plurality of sub-pixels are abnormal according to the plurality of optical measurement values. The data processing unit is coupled to the abnormal determination unit. If a determining result of the abnormal determination unit is yes, the data processing unit generates the at least one optical compensation value corresponding to the at least one abnormal sub-pixel of the plurality of sub-pixels according to the specific processing rule.

In an embodiment, the optical compensation module and the panel are both coupled to a display driving apparatus, and the display driving apparatus receives the display data and the at least one optical compensation value respectively and performs optical compensation on the display data according to the at least one optical compensation value and then outputs the optical compensated display data to the panel.

In an embodiment, when an optical measurement value of a sub-pixel of the plurality of sub-pixels is lower than a threshold value, the sub-pixel is determined as the at least one abnormal sub-pixel.

In an embodiment, when an optical measurement value of a sub-pixel of the plurality of sub-pixels does not become larger as a grayscale value increases, the sub-pixel is determined as the at least one abnormal sub-pixel.

In an embodiment, the specific processing rule is that the display data corresponding to the at least one abnormal sub-pixel is not compensated.

In an embodiment, the specific processing rule is that the display data corresponding to the at least one abnormal sub-pixel is compensated by an optical compensation value corresponding to a sub-pixel adjacent to the at least one abnormal sub-pixel.

Another preferred embodiment of the invention is an optical compensation apparatus operating method. In this embodiment, the optical compensation apparatus operating method is used for operating an optical compensation apparatus applied to a panel including a plurality of sub-pixels for displaying a display data. The optical compensation apparatus operating method includes steps of: (a) measuring a plurality of optical measurement values corresponding to the plurality of sub-pixels of the panel; (b) determining whether the plurality of sub-pixels are abnormal according to the plurality of optical measurement values; and (c) if a determining result of step (b) is yes, generating at least one optical compensation value corresponding to at least one abnormal sub-pixel of the plurality of sub-pixels according to a specific processing rule for performing optical compensation on the display data.

Compared to the prior art, even if the dust or other interferences are present on the panel during the lightness measurement process of all sub-pixels of the panel, the optical compensation apparatus and the operating method thereof according to the invention will automatically detect these abnormal sub-pixels at first and then process them appropriately instead of directly performing error optical compensation on these abnormal sub-pixels according to the wrong lightness measurement values as in the prior art.

Therefore, the optical compensation apparatus and the operating method thereof according to the invention can achieve “demura” effect and can effectively prevent the sub-pixels of the panel from displaying abnormal bright spots due to erroneous optical compensation to improve the display quality of the panel and enhance the visual experience of the user.

The advantage and spirit of the invention may be understood by the following detailed descriptions together with the appended drawings.

### BRIEF DESCRIPTION OF THE APPENDED DRAWINGS

FIG. 1A and FIG. 1B illustrate schematic diagrams of the original panel and the normal lightness of its sub-pixels respectively.

FIG. 2A and FIG. 2B illustrate schematic diagrams of the dust present on the panel and the lightness measured from the sub-pixels covered by the dust on the display panel being much lower than the normal lightness respectively.

FIG. 3A and FIG. 3B illustrate schematic diagrams of the abnormal bright spots presented on the sub-pixels of the panel and performing error compensation on the sub-pixels according to the erroneous lightness measurement values respectively.

FIG. 4 illustrates a schematic diagram of an optical compensation apparatus applied to a panel in a preferred embodiment of the invention.

FIG. 5 illustrates a schematic diagram of determining a sub-pixel having an optical measurement value lower than a threshold value as an abnormal sub-pixel.

FIG. 6 illustrates a schematic diagram of determining a sub-pixel as a normal sub-pixel when an optical measurement value of the sub-pixel becomes larger as a grayscale value increases.

FIG. 7 illustrates a schematic diagram of determining a sub-pixel as an abnormal sub-pixel when an optical measurement value of the sub-pixel does not become larger as a grayscale value increases.

FIG. 8 illustrates a schematic diagram of lightness measurement of the sub-pixels of the panel.

FIG. 9 illustrates a schematic diagram of not compensating the display data corresponding to the abnormal sub-pixels shown in FIG. 8.

FIG. 10 illustrates a schematic diagram of lightness measurement of the sub-pixels of the panel.

FIG. 11 illustrates a schematic diagram of compensating the display data corresponding to the abnormal sub-pixel by an optical compensation value corresponding to a sub-pixel adjacent to the abnormal sub-pixel.

FIG. 12 illustrates a flowchart of an optical compensation apparatus operating method in another embodiment of the invention.

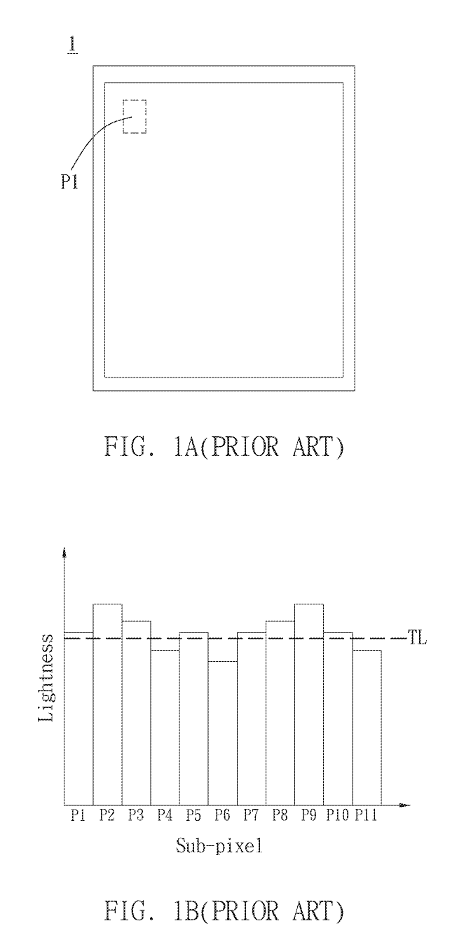

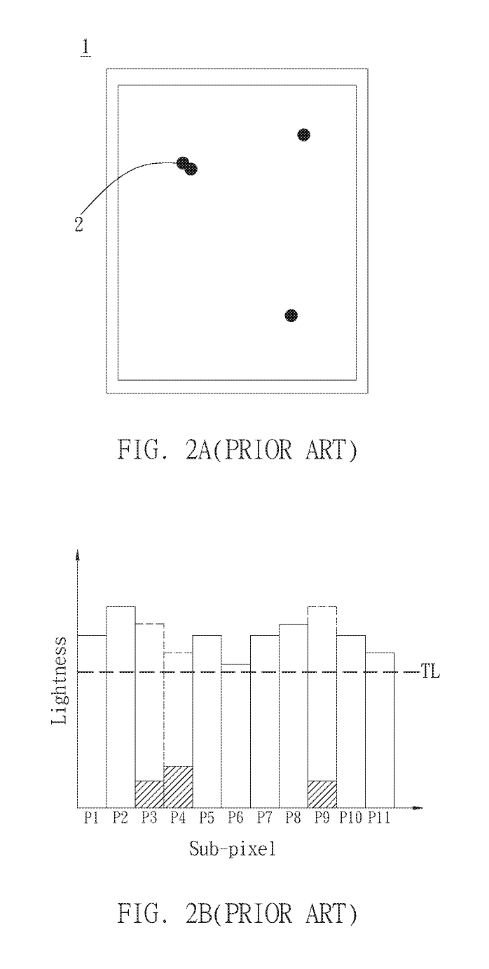

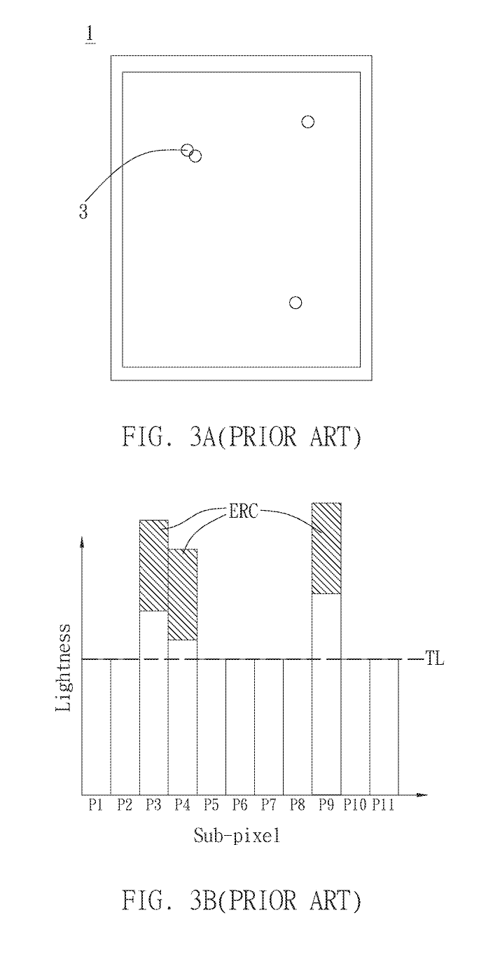

### DETAILED DESCRIPTION OF THE INVENTION

The invention discloses an optical compensation apparatus and an operating method thereof. In practical applications, even if the dust or other interferences are present on the panel during the lightness measurement process of all sub-pixels of the panel, the optical compensation apparatus and the operating method thereof in the invention can automatically detect these abnormal sub-pixels at first and then process them appropriately to achieve “demura” effect and effectively prevent the sub-pixels of the panel from displaying abnormal bright spots due to erroneous optical compensation.

A preferred embodiment of the invention is an optical compensation apparatus. In this embodiment, the optical compensation apparatus is applied to a panel (e.g., an OLED panel), but not limited to this. The panel includes a plurality of sub-pixels for displaying a display data.

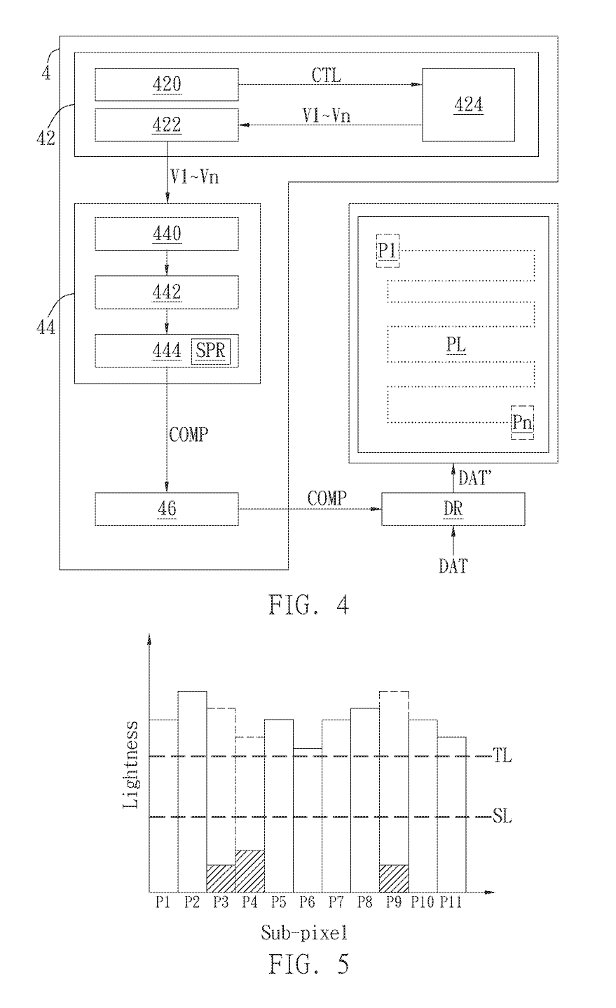

Please refer to FIG. 4. FIG. 4 illustrates a schematic diagram of an optical compensation apparatus applied to a panel in this embodiment.

As shown in FIG. 4, the optical compensation apparatus 4 is disposed corresponding to the panel PL, and the optical compensation apparatus 4 and the panel PL are both coupled to a display driving apparatus DR. The display driving apparatus DR is used to receive a display data DAT and output the display data DAT to the plurality of sub-pixels P1˜Pn of the panel PL for displaying, wherein n is a positive integer larger than 1.

The optical compensation apparatus 4 includes an optical measurement module 42, a data processing module 44 and an optical compensation module 46. The data processing module 44 is coupled to the optical measurement module 42; the optical compensation module 46 is coupled to the data processing module 44; the optical compensation module 46 is also coupled to the display driving apparatus DR.

The optical measurement module 42 is disposed corresponding to the panel PL and used for measuring a plurality of optical measurement values V1˜Vn (e.g., the lightness, but not limited to this) corresponding to the plurality of sub-pixels P1˜Pn of the panel PL.

In this embodiment, the optical measurement module 42 can include a control unit 420, a data accessing unit 422 and an optical sensing unit 424. The control unit 420 and the data accessing unit 422 are both coupled to the optical sensing unit 424.

When the control unit 420 provides a control signal CTL to the optical sensing unit 424, the optical sensing unit 424 will perform optical sensing on the plurality of sub-pixels P1˜Pn of the panel PL according to the control signal CTL to obtain the plurality of optical measurement values V1˜Vn corresponding to the plurality of sub-pixels P1˜Pn. Then, the data accessing unit 422 will access the plurality of optical measurement values V1˜Vn from the optical measuring unit 424 and then transmit the plurality of optical measurement values V1˜Vn to the data processing module 44. In practical application, the optical measuring unit 424 can be optical lens or any other device having the optical measuring function, but not limited to this.

When the data processing module 44 receives the plurality of optical measurement values V1˜Vn, the data processing module 44 determines whether the plurality of sub-pixels P1˜Pn is abnormal according to the plurality of optical measurement values V1˜Vn. As for how the data processing module 44 determines that the plurality of sub-pixels P1˜Pn is normal or abnormal, it will be described in detail later.

If a determining result of the data processing module 44 is yes, it means that at least one sub-pixel (e.g., one sub-pixel or more sub-pixels) of the plurality of sub-pixels P1˜Pn is abnormal, the data processing module 44 will determine the at least one sub-pixel as at least one abnormal sub-pixel. Then, the data processing module 44 will generate at least one optical compensation value COMP corresponding to the at least one abnormal sub-pixel according to a specific processing rule SPR and output the at least one optical compensation value COMP to the optical compensation module 46. As for what is the specific processing rule SPR used by the data processing module 44, it will be described in detail later.

If a determining result of the data processing module 44 is no, it means that the plurality of sub-pixels P1˜Pn is normal, the data processing module 44 will determine that the plurality of sub-pixels P1˜Pn are normal sub-pixels and generate a plurality of optical compensation values corresponding to the plurality of normal sub-pixels P1˜Pn. For example, the lightness of the plurality of sub-pixels P1˜Pn can be compensated to a target lightness, but not limited to this.

In this embodiment, the data processing module 44 can include a data analyzing unit 440, an abnormal determination unit 442 and a data processing unit 444. The data analyzing unit 440 is coupled to the optical measurement module 42; the abnormal determination unit 442 is coupled to the data analyzing unit 440; the data processing unit 444 is coupled to the abnormal determination unit 442 and the optical compensation module 46.

When the data analyzing unit 440 receives the plurality of optical measurement values V1˜Vn from the optical measurement module 42, the data analyzing unit 440 will analyze the plurality of optical measurement values V1˜Vn and then transmit the plurality of optical measurement values V1˜Vn to the abnormal determination unit 442.

Then, the abnormal determination unit 442 will determine whether the plurality of sub-pixels P1˜Pn are abnormal according to the plurality of optical measurement values V1˜Vn. As for how the abnormal determination unit 442 determines that the plurality of sub-pixels P1˜Pn is normal or abnormal, it will be described in detail later.

If a determining result of the abnormal determination unit 442 is yes, it means that at least one sub-pixel (e.g., one sub-pixel or more sub-pixels) of the plurality of sub-pixels P1˜Pn is abnormal; therefore, the data processing unit 444 will generate the at least one optical compensation value COMP corresponding to the at least one abnormal sub-pixel of the plurality of sub-pixels P1˜Pn according to the specific processing rule SPR and then transmit the at least one optical compensation value COMP to the optical compensation module 46.

If a determining result of the abnormal determination unit 442 is no, it means that the plurality of sub-pixels P1˜Pn is normal, the data processing unit 444 will determine that the plurality of sub-pixels P1˜Pn are normal sub-pixels and generate a plurality of optical compensation values corresponding to the plurality of normal sub-pixels P1˜Pn. For example, the lightness of the plurality of sub-pixels P1˜Pn can be compensated to a target lightness, but not limited to this.

The optical compensation module 46 is used for outputting the at least one optical compensation value COMP to the display driving apparatus DR, so that the display driving apparatus DR can perform optical compensation on the display data DAT according to the at least one optical compensation value COMP to generate an optically compensated display data DAT′. And then, the display driving apparatus DR will transmit the optically compensated display data DAT′ to the panel PL for displaying.

IT should be noticed that when the abnormal determination unit 442 determines whether the plurality of sub-pixels P1˜Pn are abnormal according to the plurality of optical measurement values V1˜Vn, the abnormal determination unit 442 can determine each sub-pixel of the plurality of sub-pixels P1˜Pn is a normal sub-pixel or an abnormal sub-pixel according to whether the plurality of optical measurement values V1˜Vn corresponding to the plurality of sub-pixels P1˜Pn is lower than a threshold value.

For example, as shown in FIG. 5, since the lightness measurement values of the sub-pixels P3, P4 and P9 of the sub-pixels P1˜P11 are lower than a threshold lightness SL, the abnormal determination unit 442 will determine the sub-pixels P3, P4 and P9 of the sub-pixels P1˜P11 as abnormal sub-pixels. And, the other sub-pixels P1˜P2, P5˜P8 and P10˜P11 of the sub-pixels P1˜P11 will be determined as normal sub-pixels. Then, the data processing unit 444 will generate different optical compensation values for the abnormal sub-pixels and the normal sub-pixels respectively.

In another embodiment, the abnormal determination unit 442 can determine each sub-pixel of the plurality of sub-pixels P1˜Pn is a normal sub-pixel or an abnormal sub-pixel according to whether the optical measurement value of each sub-pixel of the plurality of sub-pixels P1˜Pn becomes larger as a grayscale value increases.

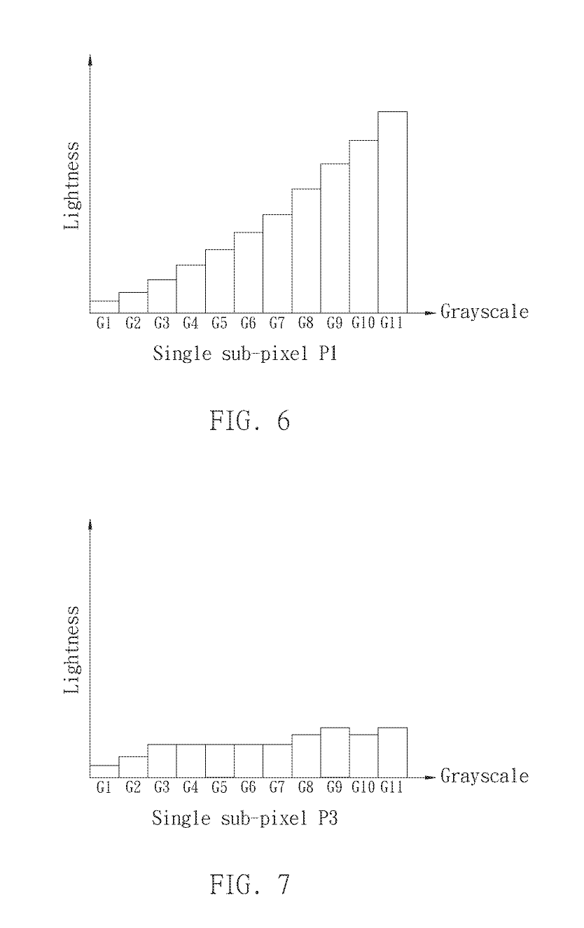

For example, as shown in FIG. 6, since the optical measurement value of the sub-pixel P1 becomes larger as the grayscale value increases, the abnormal determination unit 442 will determine the sub-pixel P1 as a normal sub-pixel; as shown in FIG. 7, since the optical measurement value of the sub-pixel P3 fails to become larger as the grayscale value increases, the abnormal determination unit 442 will determine the sub-pixel P1 as an abnormal sub-pixel. And then, the data processing unit 444 will generate different optical compensation values for the abnormal sub-pixels and the normal sub-pixels respectively.

It should be noticed that when the data processing unit 444 generates the at least one optical compensation value COMP corresponding to the at least one abnormal sub-pixel according to the specific processing rule SPR, the specific processing rule SPR can be that the display data corresponding to the at least one abnormal sub-pixel is not compensated, or the specific processing rule SPR can be that the display data corresponding to the at least one abnormal sub-pixel is compensated by an optical compensation value corresponding to a sub-pixel adjacent to the at least one abnormal sub-pixel.

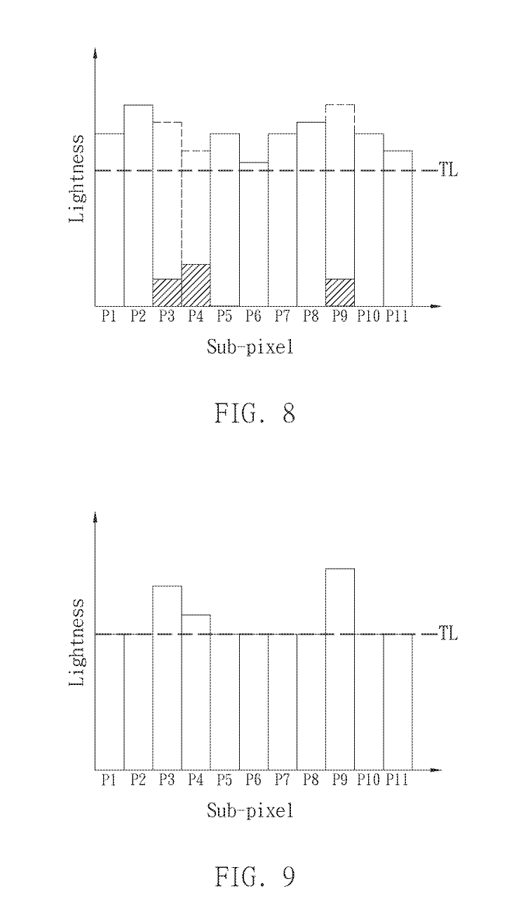

For example, the abnormal determination unit 442 can determine that the sub-pixels P3˜P4 and P9 are abnormal sub-pixels and the sub-pixels P1˜P2, P5˜P8 and P10˜P11 are normal sub-pixels according to the measured lightness of the sub-pixels P1˜P11 of the panel PL shown in FIG. 8, and then the data processing unit 444 generates the optical compensation value COMP corresponding to the abnormal sub-pixels (e.g., the sub-pixels P3˜P4 and P9) according to the specific processing rule SPR.

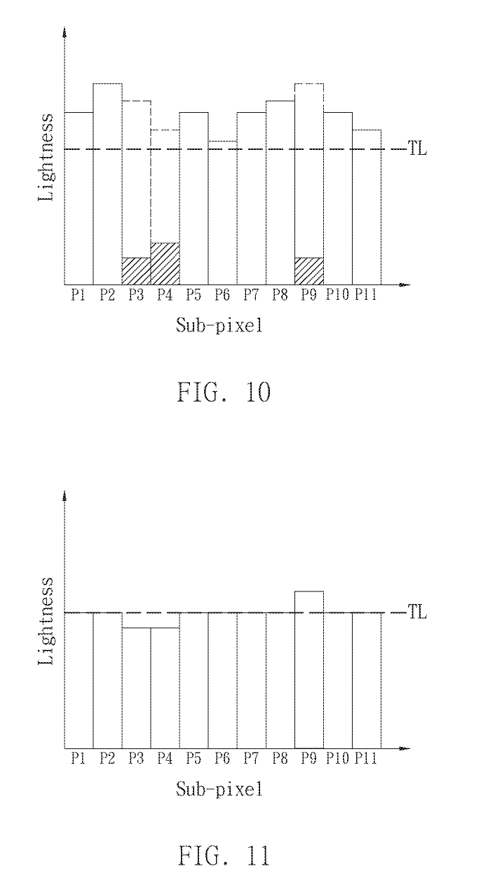

The optically compensated lightness values of the sub-pixels P1˜P11 of the panel PL are shown in FIG. 9. As shown in FIG. 9, in this embodiment, the specific processing rule SPR used by the data processing unit 444 is to maintain the original lightness values of the abnormal sub-pixels (e.g., the sub-pixels P3˜P4 and P9) without performing optical compensation on the abnormal sub-pixels. And, the lightness values of the normal sub-pixels (e.g., the sub-pixels P1˜P2, P5˜P8 and P10˜P11) will be compensated to a target lightness TL. By doing so, the abnormal bright spots displayed by the abnormal sub-pixels (e.g., the sub-pixels P3˜P4 and P9) of the panel PL due to erroneous optical compensation can be effectively avoided.

In another embodiment, the abnormal determination unit 442 can also determine that the sub-pixels P3˜P4 and P9 are abnormal sub-pixels and the sub-pixels P1˜P2, P5˜P8 and P10˜P11 are normal sub-pixels according to the measured lightness of the sub-pixels P1˜P11 of the panel PL shown in FIG. 10, and then the data processing unit 444 generates the optical compensation value COMP corresponding to the abnormal sub-pixels (e.g., the sub-pixels P3˜P4 and P9) according to the specific processing rule SPR.

The optically compensated lightness values of the sub-pixels P1˜P11 of the panel PL are shown in FIG. 11. As shown in FIG. 11, in this embodiment, the lightness values of the normal sub-pixels (e.g., the sub-pixels P1˜P2, P5˜P8 and P10˜P11) will be compensated to a target lightness TL; the specific processing rule SPR used by the data processing unit 444 is to perform optical compensation on the display data corresponding to the at least one abnormal sub-pixel (e.g., the sub-pixels P3˜P4 and P9) according to an optical compensation value corresponding to a sub-pixel adjacent to the at least one abnormal sub-pixel (e.g., the sub-pixel P2 adjacent to the abnormal sub-pixel P3, the sub-pixel P5 adjacent to the abnormal sub-pixel P4 and the sub-pixel P8 or P10 adjacent to the abnormal sub-pixel P9). By doing so, the lightness difference between the abnormal sub-pixel and the adjacent normal sub-pixel will become smaller, and the abnormal bright spots displayed by the abnormal sub-pixels (e.g., the sub-pixels P3˜P4 and P9) of the panel PL due to erroneous optical compensation can be effectively avoided.

Another preferred embodiment of the invention is an optical compensation apparatus operating method. In this embodiment, the optical compensation apparatus operating method is used for operating an optical compensation apparatus applied to a panel including a plurality of sub-pixels for displaying a display data.

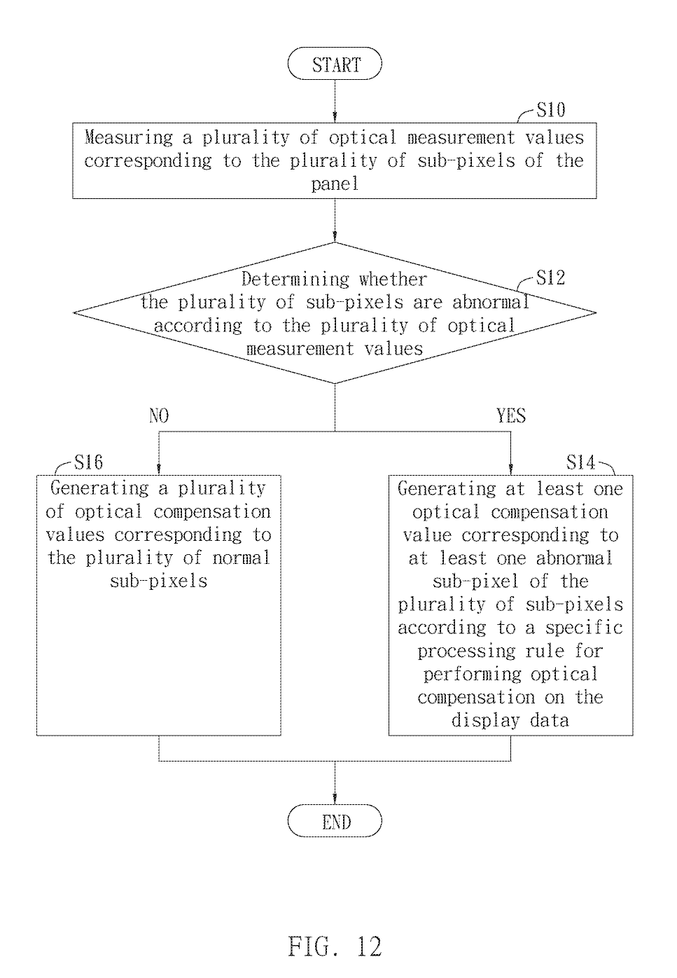

Please refer to FIG. 12. FIG. 12 illustrates a flowchart of the optical compensation apparatus operating method in this embodiment. As shown in FIG. 12, the optical compensation apparatus operating method includes following steps.

Step S10: Measuring a plurality of optical measurement values corresponding to the plurality of sub-pixels of the panel (e.g., the lightness values of the sub-pixels, but not limited to this).

Step S12: Determining whether the plurality of sub-pixels are abnormal according to the plurality of optical measurement values.

Step S14: If a determining result of step S12 is yes, generating at least one optical compensation value corresponding to at least one abnormal sub-pixel of the plurality of sub-pixels according to a specific processing rule for performing optical compensation on the display data.

Step S16: If a determining result of the step S12 is no, generating optical compensation values corresponding to the normal sub-pixels of the plurality of sub-pixels for performing optical compensation on the display data.

In the step S12, when an optical measurement value of a sub-pixel of the plurality of sub-pixels is lower than a threshold value, the method can determine the sub-pixel as the at least one abnormal sub-pixel; when an optical measurement value of a sub-pixel of the plurality of sub-pixels does not become larger as a grayscale value increases, the method can determine the sub-pixel as the at least one abnormal sub-pixel, but not limited to this.

In the step S14, the specific processing rule is that the display data corresponding to the at least one abnormal sub-pixel is not compensated or the specific processing rule is that the display data corresponding to the at least one abnormal sub-pixel is compensated by an optical compensation value corresponding to a sub-pixel adjacent to the at least one abnormal sub-pixel, but not limited to this.

In the step S16, the method can compensate the lightness of the normal sub-pixels to a target lightness, but not limited to this.

Compared to the prior art, even if the dust or other interferences are present on the panel during the lightness measurement process of all sub-pixels of the panel, the optical compensation apparatus and the operating method thereof according to the invention will automatically detect these abnormal sub-pixels at first and then process them appropriately instead of directly performing error optical compensation on these abnormal sub-pixels according to the wrong lightness measurement values as in the prior art.

Therefore, the optical compensation apparatus and the operating method thereof according to the invention can achieve “demura” effect and can effectively prevent the sub-pixels of the panel from displaying abnormal bright spots due to erroneous optical compensation to improve the display quality of the panel and enhance the visual experience of the user.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical compensation apparatus, applied to a panel comprising a plurality of sub-pixels for displaying a display data, the optical compensation apparatus comprising:
an optical measurement module, for measuring a plurality of optical measurement values corresponding to the plurality of sub-pixels of the panel;
a data processing module, coupled to the optical measurement module, for determining whether the plurality of sub-pixels is abnormal according to the plurality of optical measurement values, wherein if a determining result of the data processing module is yes, the data processing module generates at least one optical compensation value corresponding to at least one abnormal sub-pixel of the plurality of sub-pixels according to a specific processing rule; and
an optical compensation module, coupled to the data processing module, for outputting the at least one optical compensation value to perform optical compensation on the display data.

2. The optical compensation apparatus of claim 1, wherein the panel is an organic light-emitting diode (OLED) panel.

3. The optical compensation apparatus of claim 1, wherein the plurality of optical measurement values is lightness values of the plurality of sub-pixels.

4. The optical compensation apparatus of claim 1, wherein the optical measurement module comprises:
a control unit, for providing a control signal;
an optical sensing unit, coupled to the control unit, for performing optical sensing on the plurality of sub-pixels of the panel according to the control signal to obtain the plurality of optical measurement values; and
a data accessing unit, coupled to the optical sensing unit, for accessing the plurality of optical measurement values from the optical measuring unit.

5. The optical compensation apparatus of claim 1, wherein the data processing module comprises:
a data analyzing unit, coupled to the optical measurement module, for receiving and analyzing the plurality of optical measurement values;
an abnormal determination unit, coupled to the data analyzing unit, for determining whether the plurality of sub-pixels are abnormal according to the plurality of optical measurement values; and
a data processing unit, coupled to the abnormal determination unit, if a determining result of the abnormal determination unit is yes, the data processing unit generates the at least one optical compensation value corresponding to the at least one abnormal sub-pixel of the plurality of sub-pixels according to the specific processing rule.

6. The optical compensation apparatus of claim 1, wherein the optical compensation module and the panel are both coupled to a display driving apparatus, and the display driving apparatus receives the display data and the at least one optical compensation value respectively and performs optical compensation on the display data according to the at least one optical compensation value and then outputs the optical compensated display data to the panel.

7. The optical compensation apparatus of claim 1, wherein when an optical measurement value of a sub-pixel of the plurality of sub-pixels is lower than a threshold value, the sub-pixel is determined as the at least one abnormal sub-pixel.

8. The optical compensation apparatus of claim 1, wherein when an optical measurement value of a sub-pixel of the plurality of sub-pixels does not become larger as a grayscale value increases, the sub-pixel is determined as the at least one abnormal sub-pixel.

9. The optical compensation apparatus of claim 1, wherein the specific processing rule is that the display data corresponding to the at least one abnormal sub-pixel is not compensated.

10. The optical compensation apparatus of claim 1, wherein the specific processing rule is that the display data corresponding to the at least one abnormal sub-pixel is compensated by an optical compensation value corresponding to a sub-pixel adjacent to the at least one abnormal sub-pixel.

11. An optical compensation apparatus operating method, for operating an optical compensation apparatus applied to a panel comprising a plurality of sub-pixels for displaying a display data, the optical compensation apparatus operating method comprising steps of:
(a) measuring a plurality of optical measurement values corresponding to the plurality of sub-pixels of the panel;
(b) determining whether the plurality of sub-pixels are abnormal according to the plurality of optical measurement values; and
(c) if a determining result of step (b) is yes, generating at least one optical compensation value corresponding to at least one abnormal sub-pixel of the plurality of sub-pixels according to a specific processing rule for performing optical compensation on the display data.

12. The optical compensation apparatus operating method of claim 11, wherein the panel is an organic light-emitting diode (OLED) panel.

13. The optical compensation apparatus operating method of claim 11, wherein the plurality of optical measurement values is lightness values of the plurality of sub-pixels.

14. The optical compensation apparatus operating method of claim 11, wherein when an optical measurement value of a sub-pixel of the plurality of sub-pixels is lower than a threshold value, the sub-pixel is determined as the at least one abnormal sub-pixel.

15. The optical compensation apparatus operating method of claim 11, wherein when an optical measurement value of a sub-pixel of the plurality of sub-pixels does not become larger as a grayscale value increases, the sub-pixel is determined as the at least one abnormal sub-pixel.

16. The optical compensation apparatus operating method of claim 11, wherein the specific processing rule is that the display data corresponding to the at least one abnormal sub-pixel is not compensated.

17. The optical compensation apparatus operating method of claim 11, wherein the specific processing rule is that the display data corresponding to the at least one abnormal sub-pixel is compensated by an optical compensation value corresponding to a pixel adjacent to the at least one abnormal sub-pixel.
